(19) United States
(12) Patent Application Publication
(10) Pub. No.: US 2026/0313309 A1
(43) Pub. Date: Oct. 8, 2026

(54) VIRTUAL SOUND SOURCES AND RENDERING TECHNIQUES

(71) Applicants: Dolby Laboratories Licensing Corporation, San Francisco, CA (US); DOLBY INTERNATIONAL AB, Dublin (IE)

(72) Inventors: Daniel Arteaga, Barcelona (ES); Jan-Hendrik Hanschke, Nuremberg (DE); Giulio Cengarle, Barcelona (ES); Joshua B. Lando, Mill Valley, CA (US); Alan J. Seefeldt, San Francisco, CA (US)

(73) Assignees: Dolby Laboratories Licensing Corporation, San Francisco, CA (US); DOLBY INTERNATIONAL AB, Dublin (IE)

(21) Appl. No.: 19/484,990

(22) PCT Filed: May 10, 2024
(86) PCT No.: PCT/US2024/028887

§ 371 Date: Nov. 17, 2025

Related U.S. Application Data
(60) Provisional application No. 63/542,490, filed on Oct. 4, 2023.
(60) Provisional application No. 63/596,548, filed on Nov. 6, 2023.

(30) Foreign Application Priority Data
May 18, 2023 (ES) P202330385

(51) Int. Cl. H04S 7/00; G06F 3/16; H04R 3/12; H04R 5/02

(52) U.S. Cl. CPC H04S 7/302; G06F 3/162; H04R 3/12; H04R 5/02; H04S 7/305; H04S 2400/11; H04S 2400/13; H04S 2420/11

(57) ABSTRACT

Some methods may involve receiving one or more audio signals, making an estimation of the direct sound level for each loudspeaker of the set of loudspeakers in a listening area, making an estimation of the loudness of each loudspeaker in the listening area and rendering one or more audio signals for reproduction via the set of loudspeakers. The rendering may involve determining, for each audio signal, a relative activation of each loudspeaker based, at least in part, on the estimation of the direct sound level for each loudspeaker in the listening area. A combined level of activations across loudspeakers may be based, at least in part, on the estimation of the loudness of each loudspeaker in the listening area.

### CROSS-REFERENCE TO RELATED APPLICATIONS

This application claims the benefit of priority from Spanish Patent Application No. P202330385 filed May 18, 2023, U.S. Provisional Patent Application No. 63/542,490 filed Oct. 4, 2023 and U.S. Provisional Patent Application No. 63/596,548 filed Nov. 6, 2023, each of which is incorporated by reference herein in its entirety.

### TECHNICAL FIELD

The disclosure pertains to systems and methods for rendering audio for playback by a set of loudspeakers.

### BACKGROUND

Audio devices, including but not limited to smart audio devices, have been widely deployed and are becoming common features of many homes. Although existing systems and methods for controlling audio devices provide benefits, improved systems and methods would be desirable.

### NOTATION AND NOMENCLATURE

Throughout this disclosure, including in the claims, “speaker” and “loudspeaker” are used synonymously to denote any sound-emitting transducer (or set of transducers) driven by a single speaker feed. A typical set of headphones includes two speakers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

Throughout this disclosure including in the claims, the term “couples” or “coupled” is used to mean either a direct or indirect connection. Thus, if a first device couples to a second device, that connection may be through a direct connection, or through an indirect connection via other devices and connections.

### SUMMARY

At least some aspects of the present disclosure may be implemented via methods, such as audio processing methods. In some instances, the methods may be implemented, at least in part, by a control system such as those disclosed herein. Some such methods involve receiving, by a control system and via an interface system, audio data, the audio data including one or more audio signals. Some such methods involve estimating, by the control system, a direct sound level of each loudspeaker of a set of loudspeakers of an audio environment, to produce an estimation of the direct sound level for each loudspeaker in a listening area, the set of loudspeakers including two or more loudspeakers. Some such methods involve estimating, by the control system, a loudness of each loudspeaker in the set of loudspeakers, to produce an estimation of the loudness of each loudspeaker in the listening area. Some such methods involve rendering, by the control system, each of the one or more audio signals included in the audio data for reproduction via the set of loudspeakers, to produce rendered audio signals.

In some examples, the rendering may involve determining, for each audio signal, a relative activation of each loudspeaker based, at least in part, on the estimation of the direct sound level for each loudspeaker in the listening area. According to some examples, a combined level of activations across loudspeakers may be based, at least in part, on the estimation of the loudness of each loudspeaker in the listening area.

According to some examples, the method also may involve providing the rendered audio signals to the set of loudspeakers.

According to some examples, the estimation of the direct sound level may be computed, at least in part, as a function of a distance of each loudspeaker to the listening area. In some such examples, the estimation of the direct sound level may be computed from an expression of direct sound intensity, which is proportional to one divided by the distance squared. In some examples, the direct sound level may be estimated, at least in part, from one or more estimated impulse responses of each loudspeaker at the listening area. According to some examples, the estimation of the direct sound level may be carried out in at least two frequency bands.

In some examples, the audio data may include associated spatial data indicating the intended perceived spatial position corresponding to an audio signal. In some such examples, the rendering may involve determining the relative activation of each loudspeaker to achieve the intended perceived spatial position indicated by the spatial data. According to some examples, the intended perceived spatial position may be indicated by audio object metadata. In some examples, the intended perceived spatial position may be derived from an audio format corresponding to a spherical harmonics-based sound field representation, or may correspond with a channel of a channel-based audio format. According to some examples, the spherical harmonics-based sound field representation may be based on higher-order Ambisonics (HOA).

According to some examples, the direct sound levels and loudness may be estimated, at least in part, as a function of a distance from each loudspeaker to the listening area. In some such examples, the loudness may be estimated from an expression of total sound intensity, which is proportional to one divided by the distance squared plus one divided by a critical distance squared, where the critical distance is a distance from a loudspeaker at which the intensity of the direct sound is substantially equal to the intensity of reverberant sound.

In some examples, the direct sound level and loudness may be estimated, at least in part, from one or more estimated impulse responses of each loudspeaker at the listening area. In some examples, the estimation of the loudness may be carried out in at least two frequency bands.

According to some examples, at least one subset of two or more audio signals may correspond to a common audio signal. In some such examples, relative activations across the subset may be maintained while the combined level of activations across the subset is based on an estimation of the loudness of each loudspeaker in the listening area. According to some examples, the at least one subset of two or more audio signals may be generated by extracting a common signal component from two or more of the one or more audio signals.

In some examples, a first loudspeaker of the set of loudspeakers may be at a first distance from the listening area and a second loudspeaker of the set of loudspeakers may be at a second distance from the listening area. The first distance may be different from the second distance.

Some or all of the operations, functions and/or methods described herein may be performed by one or more devices according to instructions (e.g., software) stored on one or more computer-readable non-transitory media. Such non-transitory media may include one or more memory devices such as those described herein, including but not limited to one or more random access memory (RAM) devices, read-only memory (ROM) devices, etc. Accordingly, some innovative aspects of the subject matter described in this disclosure can be implemented in one or more computer-readable non-transitory media having software stored thereon.

At least some aspects of the present disclosure may be implemented via apparatus. For example, one or more devices may be capable of performing, at least in part, the methods disclosed herein. In some implementations, an apparatus may include an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A is a block diagram that shows examples of components of an apparatus capable of implementing various aspects of this disclosure.

FIG. 1B shows an example of an audio environment that includes multiple loudspeakers.

FIG. 2 shows an example of a virtual sound source that is produced via audio signals rendered for two loudspeakers.

FIG. 3 shows an example of an audio environment that includes loudspeakers at varying distances from a listening area.

FIG. 4 shows examples of audio processing sequences for adding time delays and loudness compensation gains.

FIG. 5 shows an example of an impulse response.

FIG. 6 illustrates one example of a sound decay model.

FIG. 7 shows the audio environment of FIG. 3, with two different virtual sound source locations.

FIGS. 8A and 8B shows examples of novel audio processing sequences according to some aspects of the present disclosure.

FIGS. 9A and 9B shows examples of novel audio processing sequences including loudness compensation according to some aspects of the present disclosure.

FIG. 10 shows a floor plan of a listening environment, which is a living space in this example.

FIG. 11 is a flow diagram that outlines one example of a method that may be performed by an apparatus or system such as those disclosed herein.

### DETAILED DESCRIPTION OF EMBODIMENTS

Playback of spatial audio in a consumer environment has typically been tied to a prescribed number of loudspeakers placed in prescribed positions, such as positions corresponding to Dolby 5.1 or 7.1 surround sound. In these cases, content is authored specifically for the associated loudspeakers and encoded as discrete channels, one for each loudspeaker (e.g., Dolby Digital™, Dolby Digital Plus™, etc.) More recently, immersive, object-based spatial audio formats have been introduced (such as Dolby Atmos™) which break this association between the content and specific loudspeaker locations. Instead, the content may be described as a collection of individual audio objects, each with possibly time varying metadata describing the desired perceived location of said audio objects in three-dimensional space and, in some examples, other properties of the audio object. At playback time, the audio content is transformed into loudspeaker feeds by a renderer which adapts to the number and location of loudspeakers in the playback system.

Amplitude panning is a common method for rendering spatial audio to an array of loudspeakers. Amplitude panning involves varying the amplitudes of panning gains for a given audio signal as a function of the desired spatial position of the signal such that the perceived position of the sound energy aligns with the target signal position. Amplitude panning is an apt method for rendering to a myriad of speaker layouts.

Upon thorough investigation, the inventors have found that when rendering audio data for non-equidistant loudspeakers, previously-disclosed time delay and loudness matching procedures result in the creation of virtual sound sources that are not located at their intended position. Instead, the virtual sound sources are offset towards the closer, or the closest, loudspeaker.

The present disclosure presents solutions to these challenges. In this disclosure, the inventors propose novel level compensation methods that locate the virtual sound sources at their intended positions while retaining the correct virtual sound source loudness.

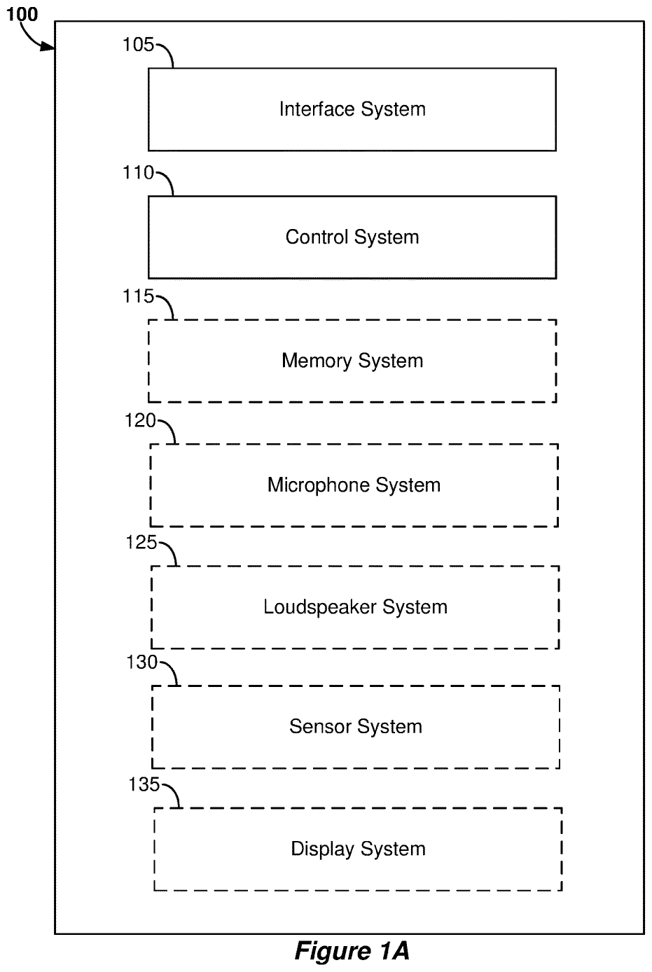

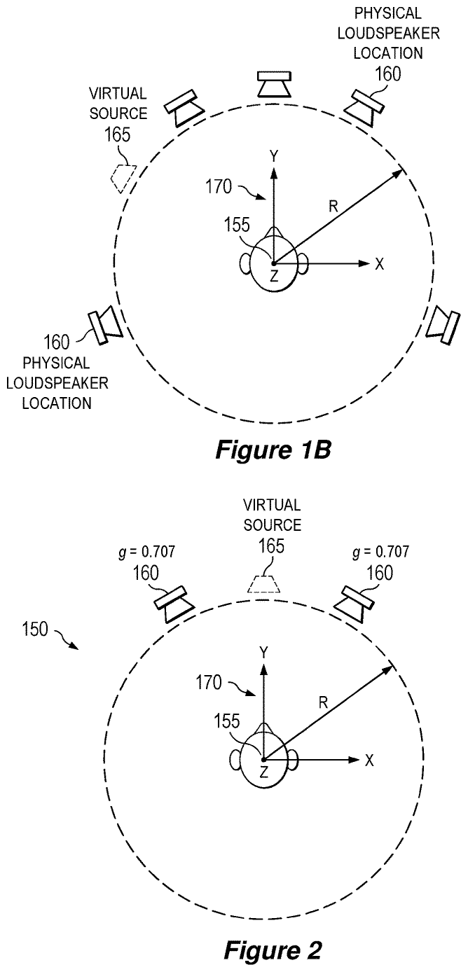

FIG. 1A is a block diagram that shows examples of components of an apparatus capable of implementing various aspects of this disclosure. As with other figures provided herein, the types and numbers of elements shown in FIG. 1A are merely provided by way of example. Other implementations may include more, fewer and/or different types and numbers of elements. According to some examples, the apparatus 100 may be, or may include, a smart audio device that is configured for performing at least some of the methods disclosed herein. In other implementations, the apparatus 100 may be, or may include, another device that is configured for performing at least some of the methods disclosed herein, such as a laptop computer, a cellular telephone, a tablet device, a smart home hub, etc. In some such implementations the apparatus 100 may be, or may include, a server.

In this example, the apparatus 100 includes an interface system 105 and a control system 110. The interface system 105 may, in some implementations, be configured for receiving audio data. The audio data may include audio signals that are to be reproduced by at least some speakers of an environment. The audio data may include one or more audio signals and associated spatial data.

The interface system 105 may be configured for providing rendered audio signals to at least some loudspeakers of the set of loudspeakers of the environment. The interface system 105 may, in some implementations, be configured for receiving input from one or more microphones in an environment.

The interface system 105 may include one or more network interfaces and/or one or more external device interfaces (such as one or more universal serial bus (USB) interfaces). According to some implementations, the interface system 105 may include one or more wireless interfaces. The interface system 105 may include one or more devices for implementing a user interface, such as one or more microphones, one or more speakers, a display system, a touch sensor system and/or a gesture sensor system. In some examples, the interface system 105 may include one or more interfaces between the control system 110 and a memory system, such as the optional memory system 115 shown in FIG. 1A. However, the control system 110 may include a memory system in some instances.

The control system 110 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 110 may reside in more than one device. For example, a portion of the control system 110 may reside in a device within one of the environments depicted herein and another portion of the control system 110 may reside in a device that is outside the environment, such as a server, a mobile device (e.g., a smartphone or a tablet computer), etc. In other examples, a portion of the control system 110 may reside in a device within one of the environments depicted herein and another portion of the control system 110 may reside in one or more other devices of the environment. For example, control system functionality may be distributed across multiple smart audio devices of an environment, or may be shared by an orchestrating device (such as what may be referred to herein as a smart home hub) and one or more other devices of the environment. The interface system 105 also may, in some such examples, reside in more than one device.

In some implementations, the control system 110 may be configured for performing, at least in part, the methods disclosed herein. According to some examples, the control system 110 may be configured for receiving audio data including one or more audio signals and for estimating a direct sound level of each loudspeaker of a set of loudspeakers of an audio environment, to produce an estimation of the direct sound level for each loudspeaker in a listening area. The listening area may be, or may correspond with, a position in which a listener is located, an area in which one or more listeners are located, etc. The set of loudspeakers may include two or more loudspeakers.

In some examples, the control system 110 may be configured for estimating a loudness of each loudspeaker in the set of loudspeakers, to produce an estimation of the loudness of each loudspeaker in the listening area. In other words, the control system 110 may be configured for making an estimation of the loudness of each loudspeaker when measured in the listening area, the loudness of each loudspeaker as perceived by a person in the listening area, etc.

According to some examples, the control system 110 may be configured for rendering each of the one or more audio signals included in the audio data for reproduction via the set of loudspeakers, to produce rendered audio signals. In some examples, the rendering may involve determining, for each audio signal, a relative activation of each loudspeaker based, at least in part, on the estimation of the direct sound level for each loudspeaker in the listening area. According to some examples, the combined level of activations across the loudspeakers may be based, at least in part, on the estimation of the loudness of each loudspeaker in the listening area.

In some examples, the estimation of the direct sound level may be computed, at least in part, as a function of the distance of each loudspeaker to the listening area. According to some examples, the estimation of the direct sound level may be computed from an expression of direct sound intensity, which is proportional to one divided by the distance squared. In some examples, the direct sound level may be estimated, at least in part, from one or more estimated impulse responses of each loudspeaker at the listening area. In some examples, an estimation of the direct sound level may be made for at least two frequency bands.

According to some examples, the audio data may include spatial data associated with the one or more audio signals. The spatial data may indicate the intended perceived spatial position corresponding to an audio signal. In some such examples, the rendering may involve determining the relative activation of each loudspeaker to achieve the intended perceived spatial position indicated by the spatial data. The spatial data corresponding to an audio signal may indicate the intended perceived spatial position of that audio signal. In some examples, the spatial data may be, or may include, audio object metadata. In some examples, the spatial data may correspond with a channel of a channel-based audio format. According to some examples, the intended perceived spatial position may be derived from the audio format, such as with higher-order Ambisonics (HOA) or other spherical harmonic based sound field representations.

FIG. 1B shows an example of an audio environment that includes multiple loudspeakers. In this example, the audio environment includes a listener, multiple physical loudspeakers 160—which also may be referred to herein as “actual loudspeakers” or simply as “loudspeakers”—and a virtual sound source 160. A virtual or phantom sound source is a sound that appears to emanate from a position other than the location of one of the physical loudspeakers 160, due to a rendering process. In this example, the locations of the loudspeakers 160 are at a constant radius R from the center of the listener's head 155. FIG. 1B shows a coordinate system 170 having its origin at the center of the listener's head 155. In this example, the positive y axis extends from the center of the listener's head 155 in the direction that the listener's head 155 is facing. The location of the listener's head 155 is one example of what may be referred to herein as a “listening position” or a “listening area.”

There are multiple rendering techniques that can create the illusion of a virtual sound source. Some of the more common rendering techniques are based on stereo amplitude panning techniques and their multichannel extensions. These rendering methods include vector-base amplitude panning (VBAP), dual/triple balance amplitude panning, center of mass amplitude panning (CMAP), distance-based amplitude panning and flexible virtualization FV). These rendering methods are based on the psychoacoustic principle of the summing localization, for example as described in Blauert, J. (1997) Spatial Hearing: The Psychophysics of Human Sound Localization. MIT Press, Cambridge. Panning methods distribute the signal to be reproduced among several loudspeakers, adjusting the relative gain of each one of the loudspeakers in a manner that the resulting sound mixture creates the illusion of a virtual sound source coming from the intended direction.

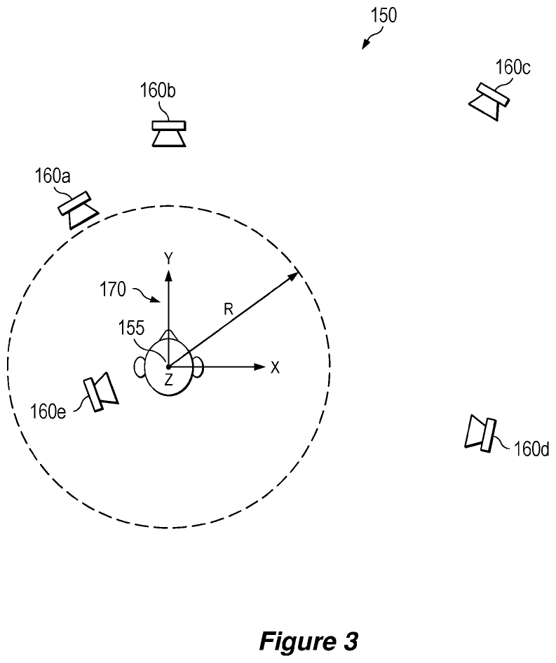

FIG. 2 shows an example of a virtual sound source that is produced via audio signals rendered for two loudspeakers. In this example, the loudspeakers 160 are positioned in a standard stereo setup, with the loudspeakers 160 positioned at +30° from the positive y axis. In other words, the loudspeakers 160 are positioned at +30° from the direction that the listener's head 155 is facing, or is expected to be facing. The reproduction of an identical signal with equal gains in both of the loudspeakers 160 creates the perceptual illusion of a virtual sound source originating from the midpoint of the two loudspeakers, located at 0°.

Provided that the loudspeakers 160 are equally calibrated to produce the same loudness at the listener's position, after the relative gains have been established, the absolute gains may be retrieved by requiring that the loudness of the virtual sound source is equal to the loudness of the corresponding sound source when emanating only from a single loudspeaker. In some cases, this process may involve normalizing each gain gᵢ according to the following equation:

$${g}_{i} \to \frac{{g}_{i}}{{( {\sum }_{j} {\vert {g}_{j} \vert}^{p} )}^{1 / p}}$$

Typical values of the exponent p range between 1 and 2, both included, with values of 1.5 and 2 being the most common.

In many traditional amplitude panning systems, these gains are positive values applied to an audio signal in a broadband manner. More generally, however, these gains may be a set of complex values that vary across frequency, thus forming a filter applied to the signal for each loudspeaker. This more general notion of possibly complex and frequency varying gains for each loudspeaker may be referred to herein as an “activation.”

Some rendering techniques, such as transaural audio, employ this more general definition of speaker activations. With transaural audio, the goal of the activations is to induce a binaural response at the ears commensurate with an intended perceived location of the audio signal. To achieve this effect, the desired frequency-varying binaural response is cascaded with the inverse of an acoustic transmission matrix that models the frequency varying transmission from each loudspeaker to the left and right ears of a listener. The result is a set of filters, or activations, for each loudspeaker. In order to maintain consistent loudness, the normalization equation from above may be applied independently at all of the frequencies associated with the activations, and the exponent p may vary across frequency, with values close to 1 being more common at low frequencies and values close to 2 being more common at medium and high frequencies.

For brevity's sake, the terms “gain” and “activation” will henceforth be used interchangeably, and it should be understood that all subsequent descriptions of gains and operations performed thereupon extend to the more general notion of activations that may vary across frequency.

### Distance Compensation

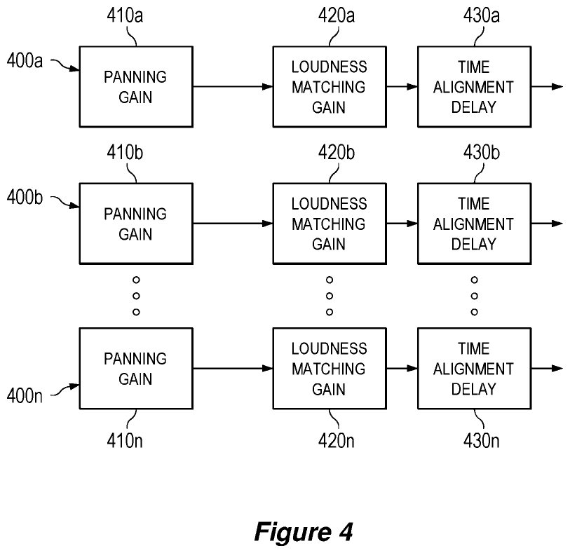

FIG. 3 shows an example of an audio environment that includes loudspeakers at varying distances from a listening area. In this example, the loudspeaker 160a is at a distance R from the center of the listener's head 155. The loudspeakers 160b, 160c and 160d are at distances greater than R from the center of the listener's head 155 and the loudspeaker 160e is at a distance of less than R from the center of the listener's head 155.

As noted above, the inventors have found that when rendering audio data for non-equidistant loudspeakers, previously-disclosed delay and loudness matching procedures result in the creation of virtual sound sources that are not located at their intended position. Instead, the virtual sound sources are offset towards the closer, or the closest, loudspeaker.

Many previously-disclosed rendering techniques depend only on the angular position of the loudspeakers relative to the listener. The distance to the various loudspeakers is assumed to be equal. In the case of unequal distances to the loudspeakers, as in the example shown in FIG. 3, the state-of-the-art procedure is to time-align and loudness-match each of the loudspeakers 160.

Loudspeaker time alignment involves adding time delays to sound emitted by the closer loudspeakers in a way that corresponding sounds emitted by all loudspeakers arrive at the listener location at the same time. The time it takes for the sound from each loudspeaker i to arrive at the listener location is dᵢ/c, where dᵢ is the distance from the loudspeaker to the listener and c is the speed of sound. The delays Δtᵢ to add to sound emitted by each loudspeaker may be expressed as follows:

$$Δ {t}_{i} = ( {d}_{r e f} - {d}_{i} ) / c ,$$

where d_{ref} represents a reference distance, which in some examples can be the distance to the most distant loudspeaker and in some other examples can be a fixed quantity larger than that: d_{ref}≥maxⱼ dⱼ.

Loudspeaker loudness matching ensures that the loudness from the different loudspeakers is substantially the same either at the listener position or across the listening area. Loudness is defined to be “the attribute of auditory sensation in terms of which sounds can be ordered on a scale extending from quiet to loud” [American National Standards Institute, “American national psychoacoustical terminology” S3.20, 1973, American Standards Association]. Empirical studies have shown that loudness correlates well with intensity estimates of the sound. [Stevens, Stanley S. “The measurement of loudness.” The Journal of the Acoustical Society of America 27.5 (1955): 815-829]. In one example, loudness can be roughly estimated by the A-level intensity of the sound as measured in decibels. In another example, loudness can be estimated more accurately by the method detailed in International Telecommunication Union Recommendation BS.1770 (ITU-R BS.1770).

In some examples, loudness may be defined as a wideband quantity. However, other examples involve considering different loudness values for each frequency band. In these latter examples, the intention is not only to compensate the broadband level of the loudspeakers, but also to equalize the different loudspeakers so that their frequency response in the layout is homogeneous. It is to be understood that all subsequent descriptions of operations performed thereupon may potentially involve the more general notion of loudness values that may vary across frequency.

Given a set of loudspeakers emitting sound at a loudness Lᵢ (as measured from the listener position), the loudness compensation ΔLᵢ for each loudspeaker may be expressed as

$$Δ {L}_{i} = {L}_{ref} - {L}_{i} ,$$

where L_{ref} represents a reference level, which can be a pre-stablished playback level. In some examples, L_{ref} may be a function of the set of levels Lᵢ. For example, L_{ref} could be the maximum, the mean or the median playback level.

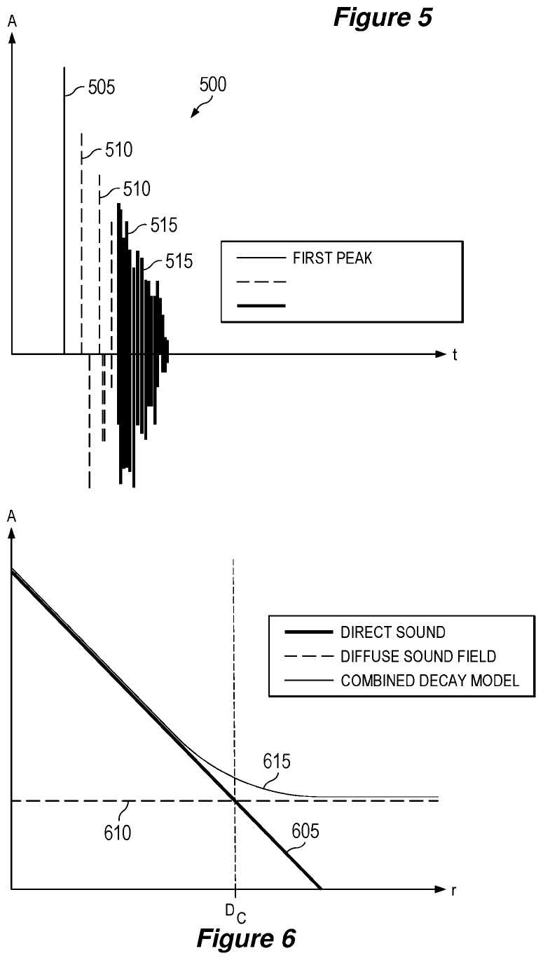

FIG. 4 shows examples of audio processing sequences for adding time delays and loudness compensation gains. In this example, an audio processing sequence or “B-chain” is shown for the audio signals provided to each loudspeaker of a set of n loudspeakers. In these examples, the B-chains are performed according to previously-disclosed methods such as those described above. Here, B-chain 400a corresponds to the audio signals provided to loudspeaker a, B-chain 400b corresponds to the audio signals provided to loudspeaker b and B-chain 400n corresponds to the audio signals provided to loudspeaker n. According to this example, panning gains are applied to audio signals in blocks 410a and 410b-410n. Here, loudness matching gains are applied in blocks 420a and 420b-420n to the audio signals with panning gains output by blocks 410a and 410b-410n. In this example, time alignment delays are applied in blocks 430a and 430b-430n to audio signals with panning gains and loudness matching gains output by blocks 420a and 420b-420n.

For a layout consisting of a set of non-equidistant loudspeakers, the state-of-the-art procedure is to add time delays and loudspeaker loudness compensation gains as the later stage of the B-chain, as shown in FIG. 4. It is to be noted that the order of the different gains and delays in FIG. 4 and subsequent figures is given for the purposes of illustration purposes: other sequences of applying the gains and delays would produce the same results. In fact, multiple gains can be combined in one single expression, for example as shown below.

The loudspeaker loudness compensation gains may be expressed as 10^{ΔL}^{ᵢ}^{/20}. The total gain Gᵢ which drives each loudspeaker may therefore be expressed as follows:

$${G}_{i} = 1 {0}^{Δ {L}_{i} / 20} {g}_{i}$$

The sound emitted by a given loudspeaker will be affected by the acoustics of the audio environment. The acoustics of a room can be understood by means of the analysis of the impulse response. The impulse response describes the response of a loudspeaker in the room to an impulsive excitation as measured from the user's position.

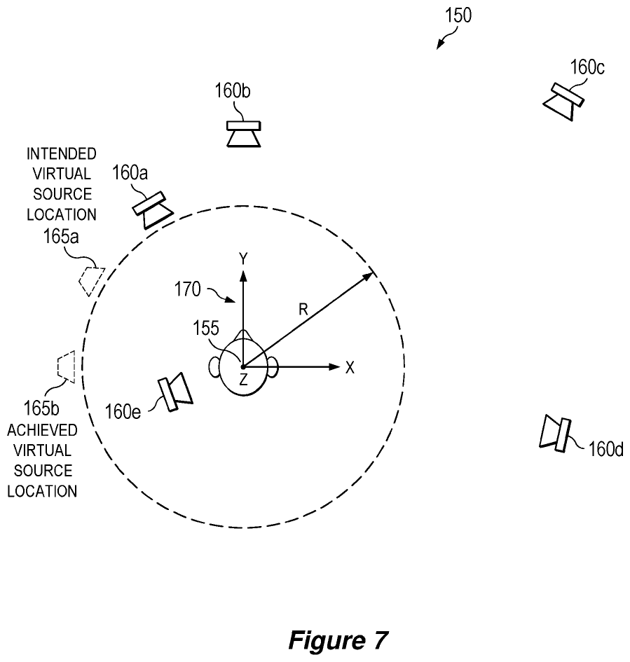

FIG. 5 shows an example of an impulse response. In FIG. 5, the vertical axis corresponds to amplitude, A, and the horizontal axis corresponds to time, t. Relevant parts of the impulse response 500 include: the first peak 505, representing the sound traveling on the shortest path from a loudspeaker to the listening area; the early reflections 510, accounting for the sound traveling to the listening area after having been reflected only a few times from the walls and objects in the room; and the reverberation tail 515, representing the sound reaching the listening area after having been reflected multiple times. The sound received at the listening area or position from any given loudspeaker, sᵢ(t), can be represented as a convolution of the impulse response from that loudspeaker to the listener's location, IRᵢ(t), by the signal emitted by the loudspeaker, s(t):

$${s}_{i} ( t ) = ( {IR}_{i} * s ) ( t )$$

In the above equation, the asterisk indicates convolution.

The aforementioned empirical studies have shown that the loudness of a sound source in a room is correlated to the total sound intensity of the sound sources in the room as measured in decibels, including thereby all parts of the impulse response: the first peak, the early reflections, and the reverberation tail.

One method to estimate the loudness of any given loudspeaker is to emit test sounds from the loudspeaker (most commonly, pink noise), and estimate the loudness at the listener position with a suitable measurement device. In one example, the loudness is estimated with a sound-level meter with appropriate weighting (e.g., A-weighting). In another example, the loudness is estimated by recording the level at the listener's position, analyzing the recording with a computer, and implementing the method of ITU-R BS.1770. In yet another example, a per-frequency-band loudness is estimated by a spectrum analyzer.

Another method to estimate the loudness of any given loudspeaker is to first measure the impulse response from the loudspeaker to the listener position, and then to simulate the sound at the listener position by convolving the signal emitted by the loudspeaker with the impulse response. In one example, loudness is estimated from the root mean square (RMS) value of simulated signal sᵢ(t) with the appropriate A-level weighting w_{A}(t):

$${L}_{i} = 10 {log}_{10} ( \frac{1}{T} {\int }_{0}^{T} {\vert ( {s}_{i} * {w}_{A} ) ( t ) \vert}^{2} d t )$$

In another example, loudness is estimated by ITU-R BS.1770, which involves, among other things, a filtering of the signal with the k-weighted filter, and a calculation of the RMS value like the one above. In yet another example, loudness per frequency band is estimated from the power spectrum of signal emitted by the loudspeaker:

$${L}_{i} ( f ) = 10 {log}_{10} ( {\int }_{f - B / 2}^{f + B / 2} \vert {\tilde{s}}_{i} ( f ) {\vert}^{2} d t )$$

In the above equation, \tilde{s} (f) represents the Fourier-transformed signal and B represents the bandwidth.

As a means of example, in the equations of this disclosure we are assuming that all signals are defined in continuous time. However, these equations would be equally valid for discrete time intervals, by replacing all integrals with appropriate summations.

In another method, the loudness at the user position can be inferred by assuming a particular sound decay model. A common decay model is one of direct sound plus diffuse sound field.

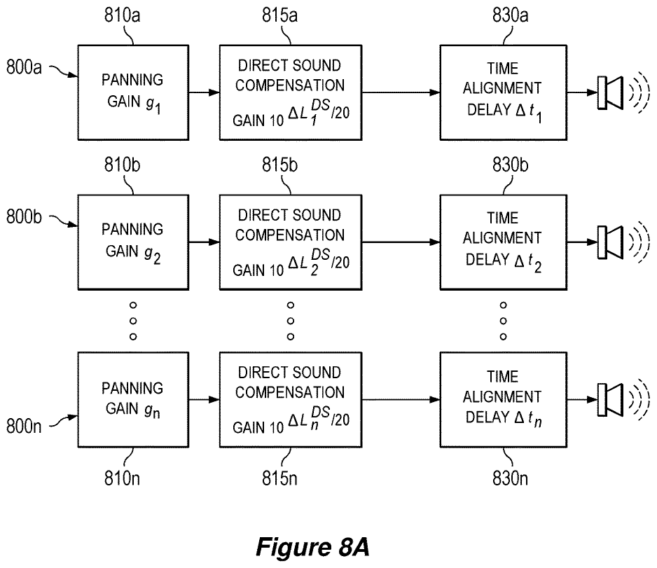

FIG. 6 illustrates one example of a sound decay model. An underlying assumption of this sound decay model is that the sound has two main components: direct sound 605, the corresponding intensity of which decays as the squared distance from the loudspeaker, accounting for the sound arriving directly from the loudspeaker to the listener—and possibly some of the early reflections—and a diffuse sound field 610, which is constant for a source in the room, accounting for the reverberation produced by the late reflections in the room. The combined decay model 615 is a summation of the direct sound 605 and the diffuse sound field 610.

This sound decay model has three parameters: the acoustic power of the sound source Pᵢ, the sound source directivity Qᵢ, and the critical distance D_{c}. All three parameters can be broadband or per frequency band, leading respectively to broadband or per frequency band loudness estimates. The critical distance D_{c} is defined to be the distance from the loudspeaker at which the direct sound and the reverberant sound field are equal. On axis, the loudness can be estimated from the total sound intensity in decibel scale as:

$${L}_{i} = 10 {log}_{10} ( \frac{{P}_{i} {Q}_{i}}{4 π} [ \frac{1}{{d}_{i}^{2}} + \frac{1}{{D}_{c}^{2}} ] )$$

For rooms of comparable volume, the longer the reverberation time, the smaller the critical distance.

Correctly Locating Virtual Sound Sources while Maintaining their Correct Loudness

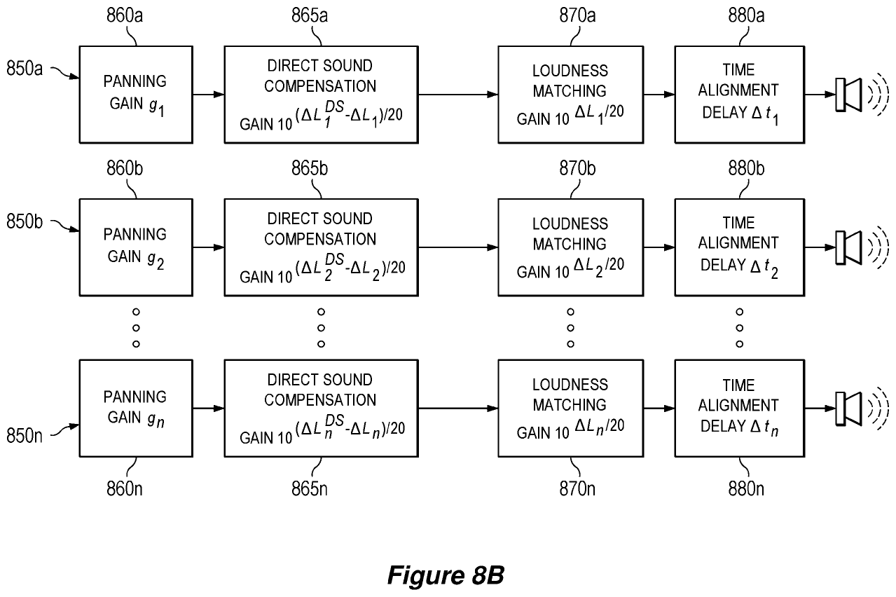

FIG. 7 shows the audio environment of FIG. 3, with two different virtual sound source locations. Upon thorough investigation, the inventors have found that for non-equidistant loudspeakers the aforementioned time delay and loudness matching procedures result in the creation of virtual sound sources that are altered from their intended position. As shown in FIG. 7, the previously-disclosed delay and loudness matching procedures result in the creation of virtual sound sources such as the achieved virtual sound source 165b, which is offset towards the closest loudspeaker 160e relative to the position of the intended virtual sound source 165a.

In this disclosure we propose novel level compensation procedures that restore the virtual sound sources to their intended positions while retaining their correct loudness.

After careful examination, the inventors have determined that the location of a virtual sound source is dominated by the early part of the impulse response from the loudspeaker to the user, namely by the first peak, and possibly by early reflections happening in a small interval after the arrival of the first peak (e.g., after less than 1 millisecond (ms)), not by the late reflections and diffuse energy in the room.

Hereafter we will refer to the early region of the impulse response, containing at least the first peak, and optionally one or more of the early reflections occurring in a small time interval after the arrival of this first peak (such as within the following 1 ms), as the “direct sound”.

While the direct sound level cannot be accurately obtained simply from the measurement of a sound level meter, there are at least two possibilities to compute or estimate the direct sound level for each loudspeaker,

$${L}_{i}^{D S} .$$

The direct sound level can be computed broadband, or by frequency band. It is to be understood that all subsequent descriptions of operations performed thereupon extend to the more general notion of direct sound values that may vary across frequency.

Some methods involve deriving the direct sound level from truncated impulse response, separating the direct sound portion of it. The direct sound portion of an impulse response can be estimated from the impulse response by multiplication of a time window w which vanishes beyond a certain truncation time t after the arrival of the first peak. Assuming the main peak arrives at time t=0, then the direct sound portion of the impulse response, IR^{DS}, can be obtained by multiplication of the impulse response by a time window w(t) as follows:

$${IR}^{DS} ( t ) = IR ( t ) w ( t ) , where \{ \begin{matrix}w ( t ) > 0 if t < τ \\ w ( t ) = 0 if t \geq τ\end{matrix}$$

The truncation time τ should be chosen carefully so that only the first peak, and optionally some of the early reflections (such as within the following 1 ms), are included.

Using a small, fixed truncation time has the inconvenience that frequencies approximately lower than the inverse truncation time cannot be adequately represented. To overcome this issue, it can be advantageous to derive the direct sound portion of the impulse response using a frequency-dependent truncation (FDT) kernel. Relevant examples are described in M. Karjalainen and T. Paatero, “Frequency-dependent signal windowing,” Proceedings of the 2001 IEEE Workshop on the Applications of Signal Processing to Audio and Acoustics (Cat. No. 01TH8575), New Platz, NY, USA, 2001, pp. 35-38, which is hereby incorporated by reference. One convenient frequency-dependent truncation filter may be expressed as follows:

$${IR}^{D S} ( t ) = {\int }_{0}^{τ} FDT ( t , {t}^{′} ) IR ( {t}^{′} ) {dt}^{′}$$

The frequency-dependent truncation filter truncates all frequency components of the impulse response to a time τ or smaller. The frequency-dependent truncation filter can truncate the lowest frequency under consideration to a time τ and higher frequencies to a time smaller than τ. This approach has the advantage of providing a better representation of the lower frequencies without compromising the truncation of the impulse response at higher frequencies.

From the truncated impulse response, the direct sound signal

$${s}_{i}^{D S} ( t )$$

can be recovered as:

$${s}_{i}^{D S} ( i ) = ( {IR}_{i}^{D S} * s ) ( t )$$

In one example, the direct sound level can be estimated from the root mean square (RMS) value of the direct sound signal, corresponding to a given test signal s(t), convolved by the A-weighting filter w_{A}(t), for example as follows:

$${L}_{i}^{D S} = 10 {log}_{10} ( \frac{1}{T} {\int }_{0}^{T} {\vert ( {s}_{i}^{D S} * {w}_{A} ) ( t ) \vert}^{2} d t )$$

In another example, the direct sound level can be estimated from the RMS value of the direct sound signal, without any weighting filter, for example as follows:

$${L}_{i}^{D S} = 10 {log}_{10} ( \frac{1}{T} {\int }_{0}^{T} {\vert {s}_{i}^{D S} ( t ) \vert}^{2} dt )$$

In yet another example, the direct sound level per frequency band can be estimated from the power spectrum of the direct sound signal, for example as follows:

$${L}_{i} ( f ) = 10 {log}_{10} ( {\int }_{f - B / 2}^{f + B / 2} {\vert {\tilde{s}}_{i}^{D S} ( {f}^{′} ) \vert}^{2} {df}^{′} )$$

In the above equation, \tilde{s}(f) represents the Fourier-transformed signal and B represents the bandwidth.

The direct sound level can also be estimated based on knowledge of sound propagation properties. The direct sound intensity decays as the squared distance from the loudspeakers. The corresponding direct sound level in decibel scale may be expressed as follows:

$${L}_{i}^{D S} = 10 {log}_{10} ( \frac{{P}_{i} {Q}_{i}}{4 π {d}_{i}^{2}} )$$

Given a set of loudspeakers whose direct sound is characterized by a level

$${L}_{i}^{D S}$$

(as measured in decibels from the user position), the direct sound compensation for each loudspeaker ΔLᵢ may be expressed as follows:

$$Δ {L}_{i}^{D S} = {L}_{ref}^{DS} - {L}_{i}^{D S}$$

In the above equation

$${L}_{ref}^{DS}$$

represents a reference direct sound level, which can be a pre-stablished direct sound level, or it can be a function of the set of direct sound levels

$${L}_{i}^{D S}$$

(e.g., maximum, median, mean).

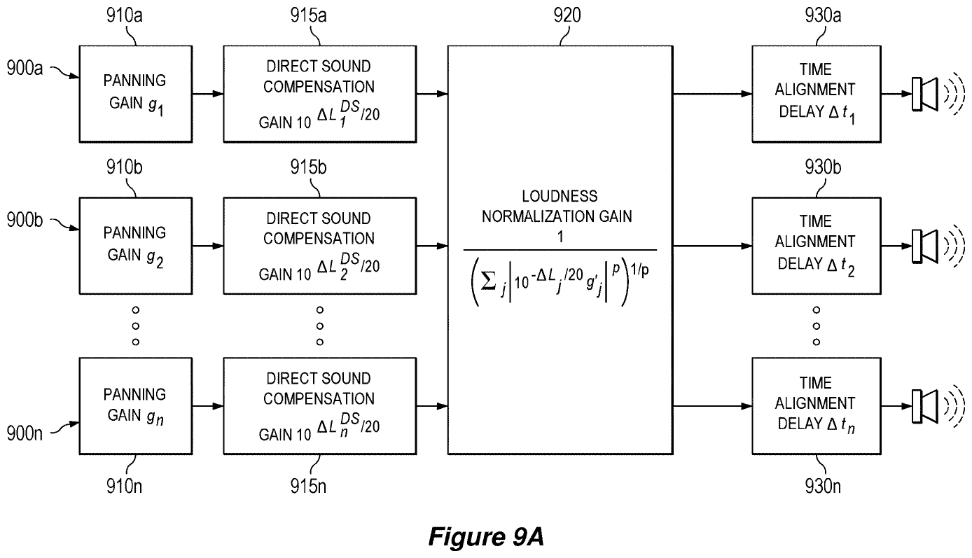

FIGS. 8A and 8B shows examples of novel audio processing sequences according to some aspects of the present disclosure. In these examples, an audio processing sequence or “B-chain” is shown for the audio signals provided to each loudspeaker of a set of n loudspeakers. In these examples, the B-chains involve processing audio signals for a layout of non-equidistant loudspeakers, examples of which are shown in FIGS. 3 and 7.

In the examples shown in FIG. 8A, B-chain 800a corresponds to the audio signals provided to loudspeaker a, B-chain 800b corresponds to the audio signals provided to loudspeaker b and B-chain 800n corresponds to the audio signals provided to loudspeaker n. According to these examples, the B-chains 800a and 800b-800n involve time aligning the audio signals—in blocks 830a and 830b-830n—but not loudness matching. In these examples, blocks 815a and 815b-815n involve applying direct sound compensation gains to preserve the correct virtual sound source locations. According to these examples, blocks 815a and 815b-815n involve modifying the panning gains gᵢ that were applied in blocks 810a and 810b-810n as follows:

$${g}_{i} \to {g}_{i}^{′} = 1 {0}^{Δ {L}_{i}^{D S} / 20} {g}_{i}$$

According to these examples, time alignment delays are applied in blocks 830a and 830b-830n to audio signals with modified panning gains output by blocks 815a and 815b-815n.

In FIG. 8B, B-chain 850a corresponds to the audio signals provided to loudspeaker a, B-chain 850b corresponds to the audio signals provided to loudspeaker b and B-chain 850n corresponds to the audio signals provided to loudspeaker n. In the examples shown in FIG. 8B, the B-chains 850a and 850b-850n include applying loudness matching gains in blocks 870a and 870b-870n, as well as applying time alignment delays in blocks 880a and 880b-880n. In these examples, audio signals are time aligned and loudness matched according to previously-disclosed methods, such as those described above. According to these examples, in order to preserve the correct virtual sound source locations, blocks 865a and 865b-865n involve modifying the panning gains gᵢ that were applied in blocks 860a and 860b-860n as follows:

$${g}_{i} \to {g}_{i}^{′} = \frac{1 {0}^{Δ {L}_{i}^{D S} / 20}}{1 {0}^{Δ {L}_{i} / 20}} {g}_{i} = 1 {0}^{( Δ {L}_{i}^{D S} - Δ {L}_{i} ) / 20} {g}_{i}$$

In the examples shown in FIGS. 8A and 8B, the total gain Gt is the same and is given by:

$${G}_{i} = 1 {0}^{Δ {L}_{i}^{D S} / 20} {g}_{i}$$

This implies that the gains fed to each loudspeaker only depend on the direct sound compensation. They additionally will obey the following equation, which shows that the relative gains need to be modified to take into account the effect of the distinct direct sound level for each loudspeaker:

$$\frac{\vert {G}_{i} \vert {10}^{- Δ {L}_{i}^{DS} / 20}}{\vert {G}_{j} \vert {10}^{- Δ {L}_{j}^{DS} / 20}} = \frac{\vert {g}_{i} \vert}{\vert {g}_{j} \vert}$$

### Loudness Compensation

The application of the aforementioned procedure will lead to virtual source images in their correct location, but the loudness of each one of the virtual sources will generally not be correct, because the loudness is governed by the intensity of the entire sound, and not only by the direct sound level. To recover the correct loudness of the virtual sound sources, gains g′ᵢ coming from the process of direct sound compensation need to be normalized.

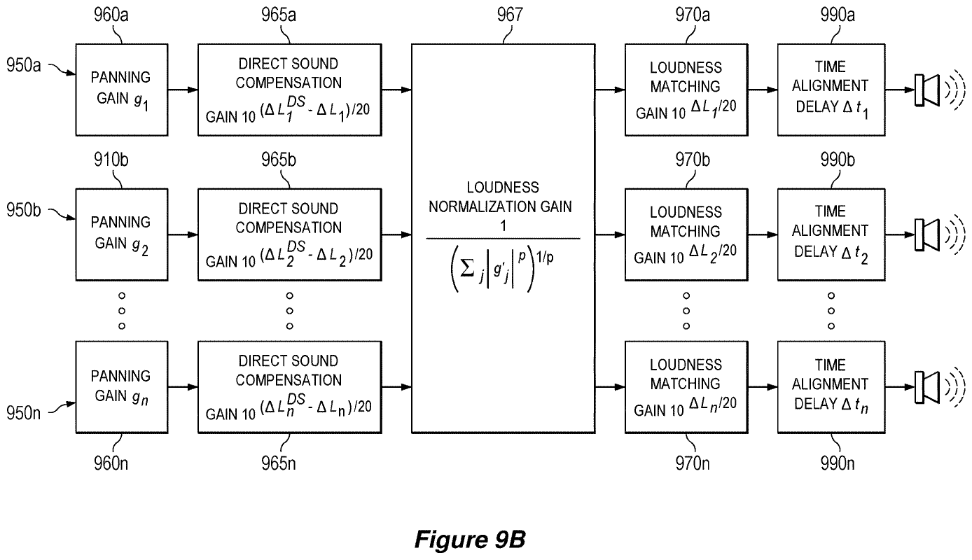

FIGS. 9A and 9B shows examples of novel audio processing sequences including loudness compensation according to some aspects of the present disclosure. In these examples, an audio processing sequence or “B-chain” is shown for the audio signals provided to each loudspeaker of a set of n loudspeakers. In these examples, the B-chains involve processing audio signals for a layout of non-equidistant loudspeakers, examples of which are shown in FIGS. 3 and 7.

According to the examples shown in FIG. 9A, the B-chains 900a and 900b-900n involve time aligning the audio signals—in blocks 930a and 930b-930n—but not loudness matching. In these examples, blocks 915a and 915b-915n involve modifying the panning gains gᵢ that were applied in blocks 910a and 910b-910n by applying direct sound compensation gains in order to preserve the correct virtual sound source locations, for example as described above with reference to FIG. 8A. According to these examples, loudness normalization gains are applied in block 920 to preserve the correct virtual source locations, as follows:

$${g}_{i}^{′} \to {g}_{i}^{″} = \frac{{g}_{i}^{′}}{{( {\sum }_{j} {\vert {g}_{j}^{′} {10}^{- Δ {L}_{i} / 20} \vert}^{p} )}^{1 / p}}$$

In the equation above, ΔL; represents the loudness compensation for loudspeaker i. In FIG. 9B, B-chain 950a corresponds to the audio signals provided to loudspeaker a, B-chain 950b corresponds to the audio signals provided to loudspeaker b and B-chain 950n corresponds to the audio signals provided to loudspeaker n. In the examples shown in FIG. 9B, the B-chains 950a and 950b-950n include applying loudness matching gains in blocks 970a and 970b-970n, as well as applying time alignment delays in blocks 990a and 990b-990n. In these examples, audio signals are time aligned and loudness matched according to previously-disclosed methods, such as those described above.

According to these examples, in order to preserve the correct virtual sound source locations, blocks 965a and 965b-965n involve modifying the panning gains g; that were applied in blocks 960a and 960b-960n as described above with reference to blocks 865a and 865b-865n of FIG. 8B. In the example shown in FIG. 9B, loudness normalization gains are applied in block 967 to preserve the correct virtual source locations, as follows:

$${g}_{i}^{′} \to {g}_{i}^{″} = \frac{{g}_{i}^{′}}{{( {\sum }_{j} {\vert {g}_{j}^{′} \vert}^{p} )}^{1 / p}}$$

In the examples shown in FIGS. 9A and 9B, after the processes of the B-chains 900a and 900b-900n or 950a and 950b-950n have been performed, the final gains Gᵢ fed to each loudspeaker may be represented as follows:

$${G}_{i} = \frac{1 {0}^{Δ {L}_{i}^{D S} / 20}}{{( {\sum }_{j} {\vert {g}_{j} 1 {0}^{( Δ {L}_{j}^{D S} - Δ {L}_{j} ) / 20} \vert}^{p} )}^{1 / p}} {g}_{i}$$

This implies that the relative gains do not change with respect to the case where no virtual source loudness normalization has been attempted; only the absolute normalization changes. Relative gains depend only on the direct sound level compensation and not on the loudness compensation:

$$\frac{\vert {G}_{i} \vert {10}^{- Δ {L}_{i}^{DS} / 20}}{\vert {G}_{j} \vert {10}^{- Δ {L}_{j}^{DS} / 20}} = \frac{\vert {g}_{i} \vert}{\vert {g}_{j} \vert}$$

In contrast, the total gain normalization factor depends on the loudness compensation. In the examples presented here:

$${( {\sum }_{j} {\vert {G}_{j} 1 {0}^{- Δ {L}_{j} / 20} \vert}^{p} )}^{1 / p} = {( {\sum }_{j} {\vert {g}_{j} \vert}^{p} )}^{1 / p} = 1$$

In other examples, the total gains may not need to be normalized to the same value of the original gains, but they may be instead normalized to a different constant K:

$${( {\sum }_{j} {\vert {G}_{j} 1 {0}^{- {ΔL}_{j} / 20} \vert}^{p} )}^{1 / p} = {K ( {\sum }_{j} {\vert {g}_{j} \vert}^{p} )}^{1 / p} = K$$

### Panning Between Virtual Sources

Thus far, the gains g; and their corresponding total gains Gᵢ have been meant to reproduce a single virtual source at an intended spatial location. A single monophonic audio signal o is multiplied with each gain Gᵢ to produce speaker signals sᵢ such that the audio signal is perceived to be coming from its intended spatial position when all speaker signals are played simultaneously:

$${s}_{i} = {G}_{i} o$$

It should be understood that all three signals above (o, Gᵢ, and sᵢ) may vary across time. In particular, if the intended position of the audio signal varies over time, then the gains Gᵢ will be updated accordingly along with the normalization procedures discussed as part of the invention.

More generally, one or more audio signals oⱼ, each with its own intended perceived spatial position, may be simultaneously rendered and mixed into the speaker signals using gains Gᵢⱼ, where i indexes the speaker signal and j indexes the audio signal:

$${s}_{i} = {\sum }_{j} {G}_{i j} {o}_{j}$$

In many cases, each audio signal oⱼ is largely perceptually independent, or decorrelated, from any other signal in the set, and each signal will be perceived as an independent audio “object” at its intended spatial position. In such a case, the disclosed loudness normalization may be applied independently for each audio signal j across the speaker signals i.

In other cases, one or more of the audio signals oⱼ may be relatively the same, or highly correlated. In such a case, the relative strength of each audio signal may be interpreted as panning a common signal across the virtual source locations associated with each signal oⱼ. In this case, the intended perceived location of the common signal will be a combination of this panning and the virtual source locations. As an example, two audio signals, o₁ and o₂, may form a stereo pair where the intended spatial positions of the signals are 30 degrees to the left and 30 degrees to the right of the listener, respectively. These locations correspond to the angular separation of a “canonical” pair of equidistant stereo loudspeakers. In stereo mixing, audio signals are often panned between the left/right speakers to create phantom sources. In particular, panning a signal equally into the left and right to form a phantom center directly in front of the listener is nearly ubiquitous for signals such as lead vocals in a music mix.

In such a case where a common source is panned across two or more virtual source locations, maintaining the intended spatial position of this common source when rendered over a set of non-equidistant loudspeakers requires that the relative gains across all of these virtual sources be set and maintained according to the disclosed direct sound compensation methods. If subsequent loudness normalization is performed independently on each virtual source location, then the relative gains between the virtual sources may be altered and the perceived location of the common source distorted. To deal with this situation, the loudness normalization may instead be applied across the entire set of virtual source locations associated with the common signal. According to one example, assuming N common audio signals, j=1 . . . N, the loudness normalization associated with FIG. 9A for a layout of non-equidistant loudspeakers which has been time aligned, but not loudness matched, may be modified as follows:

$${g}_{ij}^{′} \to {g}_{ij}^{″} = \frac{{g}_{ij}^{′}}{{( \frac{1}{N} {\sum }_{n} {\sum }_{m} {\vert {g}_{mn}^{′} {10}^{- Δ {L}_{i} / 20} \vert}^{p} )}^{1 / p}}$$

The loudness normalization associated with FIG. 9B for a layout of non-equidistant loudspeakers, the audio for which has already been time aligned and loudness matched, may be similarly modified in some examples:

$${g}_{ij}^{′} \to {g}_{ij}^{″} = \frac{{g}_{ij}^{′}}{{( \frac{1}{N} {\sum }_{n} {\sum }_{m} {\vert {g}_{mn}^{′} \vert}^{p} )}^{1 / p}}$$

In both cases, the gains for each loudspeaker across all N virtual source locations are normalized by the same amount so that their relative relationships are maintained. The normalization factor in the denominator includes an averaging of overall loudness across the N virtual sources.

In practice, one or more subsets of the overall set of audio signals oⱼ may each be associated with an independent common signal. In such cases, the above normalization may be applied independently to each subset. Any remaining individually independent signals may each be loudness normalized, for example according to the earlier-described methods.

More likely, however, is that a common signal may be panned across multiple virtual source locations along with independent signals. This is quite often the case with the earlier example of a stereo pair. A signal, such as the lead vocals, might be panned equally between left and right to create a phantom center, but other background signals might be mixed independently into left and right to create a sense of width. In such instances, it may be desirable to apply independent loudness normalization to these two virtual source locations for the independent signals while applying common loudness normalization to the center panned component. Because the common and independent signals are already mixed into the left and right signals, this loudness processing may not in general be achievable with precision. However, an approximation may be achieved by applying source separation techniques to extract the center panned component from the pair into a common left and right signal, and then generating a residual which are the remaining independent left and right signals. These two sets of separated signals may then each be rendered independently, with common loudness normalization applied to gains uses for rendering the extracted common signal and independent loudness normalization applied to the gains for rendering the left and right residuals. Such source separation methods for loudness normalization may be extended to multiple pairs of signals in the overall set of audio signals as well as to subsets of more than two signals.

One example of a practical method for extracting a common component from a pair of signals is presented in [M. Vinton, D. McGrath, C. Robinson, P. Brown, “Next Generation Surround Decoding and Upmixing for Consumer and Professional Applications”, 57th International AES Conference: The Future of Audio Entertainment Technology—Cinema, Television and the Internet (March 2015), which is hereby incorporated by reference. This method involves multiplying a time and frequency varying 2×2 separation matrix against a left and right signal pair to generate an estimate of a signal common to both. A least squares solution for the 2×2 separation matrix is derived as a function of a time and frequency varying estimate of the covariance matrix between the left and right signals, predicated on a model that the left/right signal pair contains both a common signal and uncorrelated residual signals.

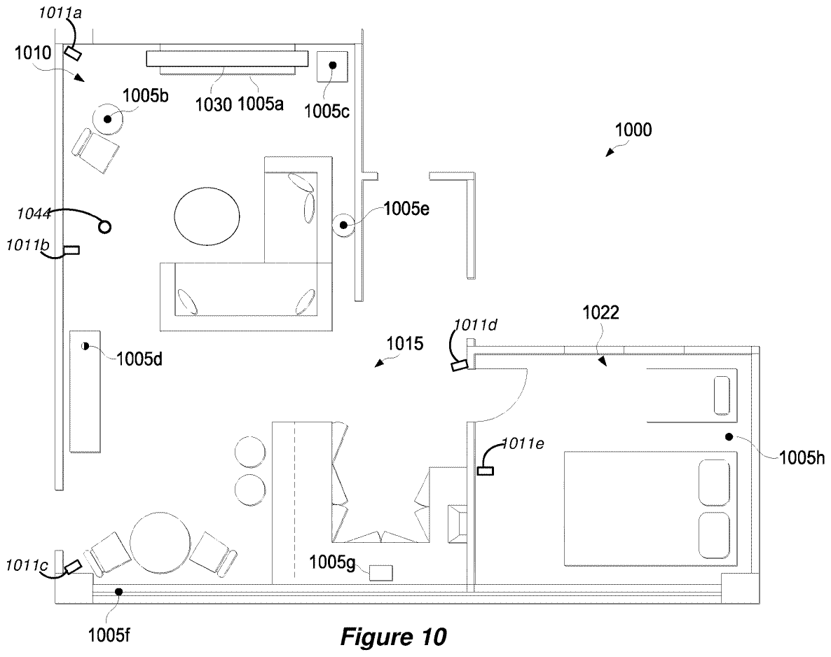

Although the previous discussion involved simple examples of loudspeaker placement, the same underlying principles apply to the flexible rendering of spatial audio over an arbitrary number of arbitrarily placed loudspeakers, such as the arbitrarily placed loudspeakers shown in FIG. 10. FIG. 10 shows a floor plan of a listening environment, which is a living space in this example. As with other figures provided herein, the types and numbers of elements shown in FIG. 10 are merely provided by way of example. Other implementations may include more, fewer and/or different types and numbers of elements. According to this example, the environment 1000 includes a living room 1010 at the upper left, a kitchen 1015 at the lower center, and a bedroom 1022 at the lower right. Boxes and circles distributed across the living space represent a set of loudspeakers 1005a-1005h, at least some of which may be smart speakers in some implementations, placed in locations convenient to the space, but not adhering to any standard prescribed layout (arbitrarily placed). In some examples, flexible rendering of spatial audio may be rendered to the loudspeakers 1005a-1005h according to one or more disclosed embodiments.

According to some examples, the environment 1000 may include a smart home hub for implementing at least some of the disclosed methods. According to some such implementations, the smart home hub may include at least a portion of the above-described control system 110. In some examples, a smart device (such as a smart speaker, a mobile phone, a smart television, a device used to implement a virtual assistant, etc.) may implement the smart home hub.

In this example, the environment 1000 includes cameras 1011a-1011e, which are distributed throughout the environment. In some implementations, one or more smart audio devices in the environment 1000 also may include one or more cameras. The one or more smart audio devices may be single purpose audio devices or virtual assistants. In some such examples, one or more cameras of the optional sensor system 130 may reside in or on the television 1030, in a mobile phone or in a smart speaker, such as one or more of the loudspeakers 1005b, 1005d, 1005e or 1005h. Although cameras 1011a-1011e are not shown in every depiction of the environment 1000 presented in this disclosure, each of the environments 1000 may nonetheless include one or more cameras in some implementations.

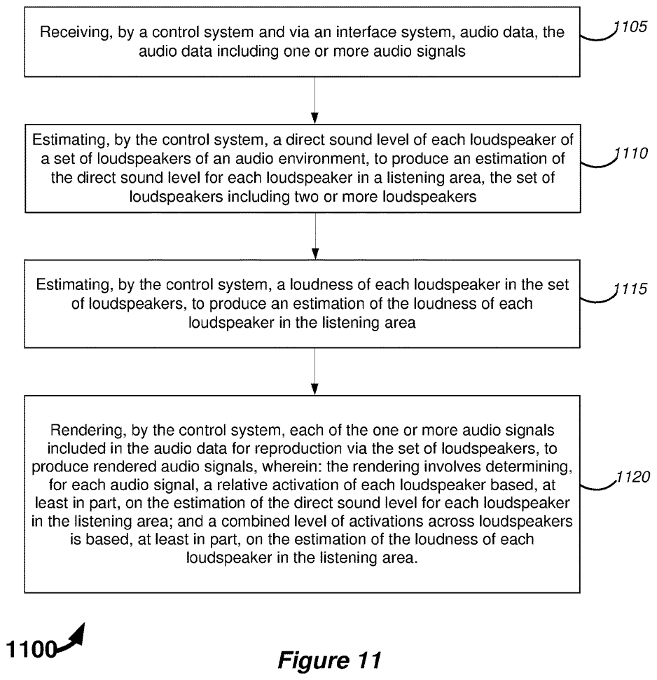

FIG. 11 is a flow diagram that outlines one example of a method that may be performed by an apparatus or system such as those disclosed herein. The blocks of method 1100, like other methods described herein, are not necessarily performed in the order indicated. In some implementation, one or more of the blocks of method 1100 may be performed concurrently. Moreover, some implementations of method 1100 may include more or fewer blocks than shown and/or described. The blocks of method 1100 may be performed by one or more devices, which may be (or may include) a control system such as the control system 110 that is shown in FIG. 1A and described above.

According to this example, block 1105 involves receiving, by a control system and via an interface system, audio data. In this example, the audio data includes one or more audio signals.

In some examples, the audio data received in block 1105 may include spatial data associated with the one or more audio signals. The spatial data may indicate an intended perceived spatial position corresponding to an audio signal. In some examples the spatial data may be, or may include, spatial metadata of an object-based audio format such as Dolby Atmos™. In some instances the spatial data may be, or may correspond with, channels of a channel-based audio format such as a Dolby 5.1, Dolby 5.1.2, Dolby 7.1, Dolby 7.1.4 or Dolby 9.1 format. Accordingly, the intended perceived spatial position may correspond with a channel of a channel-based audio format, may correspond with metadata, or may correspond with both the channel and the metadata. In some examples, the intended perceived spatial position may be derived from the audio format, such as with higher-order Ambisonics (HOA) or other spherical harmonic based sound field representations.

In this example, block 1110 involves estimating, by the control system, a direct sound level of each loudspeaker of a set of loudspeakers of an audio environment, to produce an estimation of the direct sound level for each loudspeaker in a listening area. According to this example, the set of loudspeakers includes two or more loudspeakers. In some examples, there may be an unequal distance from one or more loudspeakers to the listening area. For example, a first loudspeaker of the set of loudspeakers may be at a first distance from the listening area and a second loudspeaker of the set of loudspeakers may be at a second distance from the listening area, the first distance being different from the second distance. FIG. 7 shows one example of loudspeakers at unequal distances from the listening area.

In some examples, the estimation of the direct sound level may be computed, at least in part, as a function of a distance of each loudspeaker to the listening area. According to some examples, the estimation of the direct sound level may be computed from an expression of direct sound intensity, which is proportional to one divided by the distance squared. In some examples, the direct sound level may be estimated, at least in part, from one or more estimated impulse responses of each loudspeaker at the listening area. According to some examples, the estimation of the direct sound level may be carried out in at least two frequency bands.

In some examples, the direct sound levels and loudness may be estimated, at least in part, as a function of a distance from each loudspeaker to the listening area. According to some examples, the direct sound level and loudness may be estimated, at least in part, from one or more estimated impulse responses of each loudspeaker at the listening area.

According to this example, block 1115 involves estimating, by the control system, a loudness of each loudspeaker in the set of loudspeakers, to produce an estimation of the loudness of each loudspeaker in the listening area. In some examples, the loudness may be estimated from an expression of total sound intensity, which is proportional to one divided by the distance squared plus one divided by the critical distance squared. The critical distance is a distance from a loudspeaker at which the intensity of the direct sound is substantially equal to the intensity of the reverberant sound. According to some examples, the estimation of the loudness may be carried out in at least two frequency bands.

In this example, block 1120 involves rendering, by the control system, each of the one or more audio signals included in the audio data for reproduction via the set of loudspeakers, to produce rendered audio signals. According to this example, block 1120 involves determining, for each audio signal, a relative activation of each loudspeaker based, at least in part, on the estimation of the direct sound level for each loudspeaker in the listening area. In this example, the combined level of activations across loudspeakers is based, at least in part, on the estimation of the loudness of each loudspeaker in the listening area. According to some examples, method 1100 may involve providing the rendered audio signals to the set of loudspeakers.

According to some examples, at least one subset of two or more audio signals may correspond to a common audio signal. In some such examples, the relative activations across the subset may be maintained while the combined level of activations across the subset is based on an estimation of the loudness of each loudspeaker in the listening area. According to some examples, at least one subset of two or more audio signals may be generated by extracting a common signal component from two or more of the one or more audio signals.

According to some examples, method 1100 may involve obtaining, by the control system, loudspeaker location data indicating locations of each loudspeaker of a set of loudspeakers including two or more loudspeakers with respect to a desired listening position or area. According to some examples, method 1100 may involve obtaining the loudspeaker location data and/or location data corresponding to the desired listening position or area from a data structure stored in a memory of, or accessible by, the control system. In other examples, method 1100 may involve determining the loudspeaker location data and/or location data corresponding to the desired listening position or area.

The loudspeaker location data and/or location data corresponding to the desired listening position or area may be obtained through numerous mechanisms known in the art. In some applications, such as an automobile cabin, these locations and orientations are fixed and can be physically measured, e.g. with a tape measure or from CAD designs. Other applications, such as the home environment shown in FIG. 6, may require a more adaptable approach that can automatically detect these locations and orientations through a one-time setup procedure or even dynamically across time. In Hess, Wolfgang, Head-Tracking Techniques for Virtual Acoustic Applications, (AES 133rd Convention, October 2012), which is hereby incorporated by reference, numerous commercially available techniques for tracking both the position and orientation of a listener's head in the context of spatial audio reproduction systems are presented. One particular example discussed is the Microsoft Kinect. With its depth sensing and standard cameras along with a publicly available software (Windows Software Development Kit (SDK)), the positions and orientations of the heads of several listeners in a space can be simultaneously tracked using a combination of skeletal tracking and facial recognition. Although the Kinect for Windows has been discontinued, the Azure Kinect developer kit (DK), which implements the next generation of Microsoft's depth sensor, is currently available.

In U.S. Pat. No. 10,779,084, entitled “Automatic Discovery and Localization of Speaker Locations in Surround Sound Systems,” which is hereby incorporated by reference, a system is described which can automatically locate the positions of loudspeakers and microphones in a listening environment by acoustically measuring the time-of-arrival (TOA) between each speaker and microphone. A listening position or area may be detected by placing and locating a microphone at a desired listening position (a microphone in a mobile phone held by the listener, for example), and an associated listening orientation may be defined by placing another microphone at a point in the viewing direction of the listener, e.g. at the TV. Alternatively, the listening orientation may be defined by locating a loudspeaker in the viewing direction, e.g. the loudspeakers on the TV.

In Shi, Guangi et al, Spatial Calibration of Surround Sound Systems including Listener Position Estimation, (AES 137th Convention, October 2014), which is hereby incorporated by reference, a system is described in which a single linear microphone array associated with a component of the reproduction system whose location is predictable, such as a soundbar a front center speaker, measures the time-difference-of-arrival (TDOA) for both satellite loudspeakers and a listener to locate the positions of both the loudspeakers and listener. In this case, the listening orientation is inherently defined as the line connecting the detected listening position and the component of the reproduction system that includes the linear microphone array, such as a sound bar that is co-located with a television (placed directly above or below the television). Because the sound bar's location is predictably placed directly above or below the video screen, the geometry of the measured distance and incident angle can be translated to an absolute position relative to any point in front of that reference sound bar location using simple trigonometric principles. The distance between a loudspeaker and a microphone of the linear microphone array can be estimated by playing a test signal and measuring the time of flight (TOF) between the emitting loudspeaker and the receiving microphone. The time delay of the direct component of a measured impulse response can be used for this purpose. The impulse response between the loudspeaker and a microphone array element can be obtained by playing a test signal through the loudspeaker under analysis. For example, either a maximum length sequence (MLS) or a chirp signal (also known as logarithmic sine sweep) can be used as the test signal. The room impulse response can be obtained by calculating the circular cross-correlation between the captured signal and the MLS input. FIG. 2 of this reference shows an echoic impulse response obtained using a MLS input. This impulse response is said to be similar to a measurement taken in a typical office or living room. The delay of the direct component is used to estimate the distance between the loudspeaker and the microphone array element. For loudspeaker distance estimation, any loopback latency of the audio device used to playback the test signal should be computed and removed from the measured TOF estimate.

International Publication Number WO 2022/118072, entitled “Pervasive Acoustic Mapping,” which is hereby incorporated by reference, discloses additional methods for estimating loudspeaker location data and location data corresponding to the desired listening position or area. This disclosure describes multiple techniques that may be used in various combinations in order to provide automated acoustic mapping. The acoustic mapping may be pervasive and ongoing. Such acoustic mapping may sometimes be referred to as “continuous,” in the sense that the acoustic mapping may be continued after an initial set-up process and may be responsive to changing conditions in the audio environment, such as changing noise sources and/or levels, loudspeaker relocation, the deployment of additional loudspeakers, the relocation and/or re-orientation of one or more listeners, etc. Some disclosed methods involve generating calibration signals that are injected (e.g., mixed) into the audio content being rendered by audio devices in an audio environment. In some such examples, the calibration signals may be, or may include, acoustic direct sequence spread spectrum (DSSS) signals. In other examples, the calibration signals may be, or may include, other types of acoustic calibration signals, such as swept sinusoidal acoustic signals, white noise, “colored noise,” such as pink noise (a spectrum of frequencies that decreases in intensity at a rate of three decibels per octave), acoustic signals corresponding to music, etc.

United States Patent Application Publication No. 2023/0040846 A1, entitled “Audio Device Auto-Location,” which is hereby incorporated by reference, discloses additional methods for estimating loudspeaker location data and location data corresponding to the desired listening position or area. Some disclosed methods for estimating an audio device location in an environment involve obtaining direction of arrival (DOA) data for each audio device of a plurality of audio devices in the environment and determining interior angles for each of a plurality of triangles based on the DOA data. Each triangle has vertices that correspond with audio device locations. The method involves determining a side length for each side of each of the triangles, performing a forward alignment process of aligning each of the plurality of triangles produce a forward alignment matrix and performing a reverse alignment process of aligning each of the plurality of triangles in a reverse sequence to produce a reverse alignment matrix. A final estimate of each audio device location is based, at least in part, on values of the forward alignment matrix and values of the reverse alignment matrix. Some such methods may yield a result that is correct up to an unknown scale and rotation. In many applications, absolute scale is unnecessary, and rotations can be resolved by placing additional constraints on the solution. For example, some multi-speaker environments may include television (TV) speakers and a couch positioned for TV viewing. After locating the speakers in the environment, some methods may involve finding a vector pointing to the TV and locating the speech of a user sitting on the couch by triangulation. Some such methods may then involve having the TV emit a sound from its speakers and/or prompting the user to walk up to the TV and locating the user's speech by triangulation. Some implementations may involve rendering an audio object that pans around the environment. A user may provide user input (e.g., saying “Stop”) indicating when the audio object is in one or more predetermined positions within the environment, such as the front of the environment, at a TV location of the environment, etc. According to some such examples, after locating the speakers within an environment and determining their orientation, the user may be located by finding the intersection of directions of arrival of sounds emitted by multiple speakers. Some implementations involve determining an estimated distance between at least two audio devices and scaling the distances between other audio devices in the environment according to the estimated distance.

As can be seen, there exist numerous mechanisms through which loudspeaker location data and location data corresponding to the desired listening position or area may be obtained, and all such methods (as well as relevant future methods that may be developed) are meant to be applicable to the implementations of the present disclosure. Accordingly, the specific details disclosed herein should merely be regarded as examples.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 115 shown in FIG. 1A and/or in the control system 110. Accordingly, various innovative aspects of the subject matter described in this disclosure can be implemented in one or more non-transitory media having software stored thereon. The software may, for example, include instructions for controlling at least one device to process audio data. The software may, for example, be executable by one or more components of a control system such as the control system 110 of FIG. 1A.

In some examples, the apparatus 100 may include the optional microphone system 120 shown in FIG. 1A. The optional microphone system 120 may include one or more microphones. In some implementations, one or more of the microphones may be part of, or associated with, another device, such as a speaker of the speaker system, a smart audio device, etc.

According to some implementations, the apparatus 100 may include the optional loudspeaker system 125 shown in FIG. 1A. The optional loudspeaker system 125 may include one or more loudspeakers. Loudspeakers may sometimes be referred to herein as “speakers.” In some examples, at least some loudspeakers of the optional loudspeaker system 125 may be arbitrarily located. For example, at least some speakers of the optional loudspeaker system 125 may be placed in locations that do not correspond to any standard prescribed speaker layout, such as Dolby 5.1, Dolby 5.1.2, Dolby 7.1, Dolby 7.1.4, Dolby 9.1, Hamasaki 22.2, etc. In some such examples, at least some loudspeakers of the optional loudspeaker system 125 may be placed in locations that are convenient to the space (e.g., in locations where there is space to accommodate the loudspeakers), but not in any standard prescribed loudspeaker layout.

In some implementations, the apparatus 100 may include the optional sensor system 130 shown in FIG. 1A. The optional sensor system 130 may include one or more cameras, touch sensors, gesture sensors, motion detectors, etc. According to some implementations, the optional sensor system 130 may include one or more cameras. In some implementations, the cameras may be free-standing cameras. In some examples, one or more cameras of the optional sensor system 130 may reside in a smart audio device, which may be a single purpose audio device or a virtual assistant. In some such examples, one or more cameras of the optional sensor system 130 may reside in a TV, a mobile phone or a smart speaker.

In some implementations, the apparatus 100 may include the optional display system 135 shown in FIG. 1A. The optional display system 135 may include one or more displays, such as one or more light-emitting diode (LED) displays. In some instances, the optional display system 135 may include one or more organic light-emitting diode (OLED) displays. In some examples wherein the apparatus 100 includes the display system 135, the sensor system 130 may include a touch sensor system and/or a gesture sensor system proximate one or more displays of the display system 135. According to some such implementations, the control system 110 may be configured for controlling the display system 135 to present a graphical user interface (GUI), such as one of the GUIs disclosed herein.

According to some examples the apparatus 100 may be, or may include, a smart audio device. In some such implementations the apparatus 100 may be, or may include, a wakeword detector. For example, the apparatus 100 may be, or may include, a virtual assistant.

Some disclosed implementations include a system or device configured (e.g., programmed) to perform any embodiment of the disclosed methods, and a tangible computer readable medium (e.g., a disc) which stores code for implementing any embodiment of the disclosed methods or steps thereof. For example, the disclosed system can be or include a programmable general purpose processor, digital signal processor, or microprocessor, programmed with software or firmware and/or otherwise configured to perform any of a variety of operations on data, including an embodiment of the disclosed method or steps thereof. Such a general purpose processor may be or include a computer system including an input device, a memory, and a processing subsystem that is programmed (and/or otherwise configured) to perform an embodiment of the disclosed method (or steps thereof) in response to data asserted thereto.

Some embodiments of the disclosed system are implemented as a configurable (e.g., programmable) digital signal processor (DSP) that is configured (e.g., programmed and otherwise configured) to perform required processing on audio signal(s), including performance of an embodiment of the disclosed method. Alternatively, embodiments of the disclosed system (or elements thereof) are implemented as a general purpose processor (e.g., a personal computer (PC) or other computer system or microprocessor, which may include an input device and a memory) which is programmed with software or firmware and/or otherwise configured to perform any of a variety of operations including an embodiment of the disclosed method. Alternatively, elements of some embodiments of the disclosed system are implemented as a general purpose processor or DSP configured (e.g., programmed) to perform an embodiment of the disclosed method, and the system also includes other elements (e.g., one or more loudspeakers and/or one or more microphones). A general purpose processor configured to perform an embodiment of the disclosed method would typically be coupled to an input device (e.g., a mouse and/or a keyboard), a memory, and a display device.

Another aspect of the present disclosure is a computer readable medium (for example, a disc or other tangible storage medium) which stores code for performing (e.g., coder executable to perform) any disclosed method or steps thereof.

While specific embodiments and applications have been described herein, it will be apparent to those of ordinary skill in the art that many variations on the embodiments and applications described herein are possible without departing from the scope described and claimed herein. It should be understood that while certain forms have been shown and described, the scope of the present disclosure is not to be limited to the specific embodiments described and shown or the specific methods described.

Various aspects of the present disclosure may be appreciated from the following Enumerated Example Embodiments (EEEs):
EEE1. An audio processing method, comprising:
   receiving, by a control system and via an interface system, audio data, the audio data including one or more audio signals;
   estimating, by the control system, a direct sound level of each loudspeaker of a set of loudspeakers of an audio environment, to produce an estimation of the direct sound level for each loudspeaker in a listening area, the set of loudspeakers including two or more loudspeakers;
   estimating, by the control system, a loudness of each loudspeaker in the set of loudspeakers, to produce an estimation of the loudness of each loudspeaker in the listening area;
   rendering, by the control system, each of the one or more audio signals included in the audio data for reproduction via the set of loudspeakers, to produce rendered audio signals, wherein:
      the rendering involves determining, for each audio signal, a relative activation of each loudspeaker based, at least in part, on the estimation of the direct sound level for each loudspeaker in the listening area; and
      a combined level of activations across loudspeakers is based, at least in part, on the estimation of the loudness of each loudspeaker in the listening area.
EEE2. The method of EEE1, wherein the estimation of the direct sound level is computed, at least in part, as a function of a distance of each loudspeaker to the listening area.
EEE3. The method of EEE2, wherein the estimation of the direct sound level is computed from an expression of direct sound intensity, which is proportional to one divided by the distance squared.
EEE4. The method of EEE1, wherein the direct sound level is estimated, at least in part, from one or more estimated impulse responses of each loudspeaker at the listening area.
EEE5. The method of any one of EEE1 to EEE4, wherein the estimation of the direct sound level is carried out in at least two frequency bands.
EEE6. The method of any one of EEE1 to EEE5, wherein the audio data includes associated spatial data, the spatial data indicating the intended perceived spatial position corresponding to an audio signal, and wherein the rendering involves determining the relative activation of each loudspeaker to achieve the intended perceived spatial position indicated by the spatial data.
EEE7. The method of EEE6, wherein the intended perceived spatial position is indicated by audio object metadata or can be derived from an audio format corresponding to a spherical harmonics-based sound field representation, or corresponds with a channel of a channel-based audio format.
EEE8. The method of EEE7, wherein the spherical harmonics-based sound field representation is based on higher-order Ambisonics (HOA).
EEE9. The method of any one of EEE1 to EEE8, wherein the direct sound levels and loudness are estimated, at least in part, as a function of a distance from each loudspeaker to the listening area.
EEE10. The method of EEE9, wherein the loudness is estimated from an expression of total sound intensity, which is proportional to one divided by the distance squared plus one divided by a critical distance squared, where the critical distance is a distance from a loudspeaker at which the intensity of the direct sound is substantially equal to the intensity of reverberant sound.
EEE11. The method of EEE1, wherein the direct sound level and loudness are estimated, at least in part, from one or more estimated impulse responses of each loudspeaker at the listening area.
EEE12. The method of any one of EEE1 to EEE11, wherein the estimation of the loudness is carried out in at least two frequency bands.
EEE13. The method of any one of EEE1 to EEE12, wherein at least one subset of two or more audio signals corresponds to a common audio signal, and wherein relative activations across the subset are maintained while the combined level of activations across the subset is based on an estimation of the loudness of each loudspeaker in the listening area.
EEE14. The method of EEE13, wherein the at least one subset of two or more audio signals is generated by extracting a common signal component from two or more of the one or more audio signals.
EEE15. The method of any one of EEE1 to EEE14, wherein a first loudspeaker of the set of loudspeakers is at a first distance from the listening area and a second loudspeaker of the set of loudspeakers is at a second distance from the listening area and wherein the first distance is different from the second distance.
EEE16. The method of any one of EEE1 to EEE15, further comprising providing the rendered audio signals to the set of loudspeakers.
EEE17. An apparatus configured to perform the method of any one of EEE1 to EEE16.
EEE18. A system configured to perform the method of any one of EEE1 to EEE16.
EEE19. One or more computer-readable and non-transitory media having instructions encoded thereon for performing the method of any one of EEE1 to EEE16.

1. An audio processing method, comprising:
receiving, by a control system and via an interface system, audio data, the audio data including one or more audio signals;
estimating, by the control system, a direct sound level of each loudspeaker of a set of loudspeakers of an audio environment, to produce an estimation of the direct sound level for each loudspeaker in a listening area, the set of loudspeakers including two or more loudspeakers;
estimating, by the control system, a loudness of each loudspeaker in the set of loudspeakers, to produce an estimation of the loudness of each loudspeaker in the listening area;
rendering, by the control system, each of the one or more audio signals included in the audio data for reproduction via the set of loudspeakers, to produce rendered audio signals, wherein:
the rendering involves determining, for each audio signal, a relative gain of each loudspeaker based, at least in part, on the estimation of the direct sound level for each loudspeaker in the listening area, wherein the relative gains of the loudspeakers are normalized by the same amount by a normalization factor based, at least in part, on the estimation of the loudness of each loudspeaker in the listening area.

2. The method of claim 1, wherein the estimation of the direct sound level is computed, at least in part, as a function of a distance of each loudspeaker to the listening area.

3. The method of claim 2, wherein the estimation of the direct sound level is computed from an expression of direct sound intensity, which is proportional to one divided by the distance squared.

4. The method of claim 1, wherein the direct sound level is estimated, at least in part, from one or more estimated impulse responses of each loudspeaker at the listening area.

5. The method of claim 1, wherein the estimation of the direct sound level is carried out in at least two frequency bands.

6. The method of claim 1, wherein the audio data includes associated spatial data, the spatial data indicating the intended perceived spatial position corresponding to an audio signal, and wherein the rendering involves determining the relative gain of each loudspeaker to achieve the intended perceived spatial position indicated by the spatial data.

7. The method of claim 6, wherein the intended perceived spatial position is indicated by audio object metadata or can be derived from an audio format corresponding to a spherical harmonics-based sound field representation, or corresponds with a channel of a channel-based audio format.

8. The method of claim 7, wherein the spherical harmonics-based sound field representation is based on higher-order Ambisonics (HOA).

9. The method of claim 1, wherein the direct sound levels and loudness are estimated, at least in part, as a function of a distance from each loudspeaker to the listening area.

10. The method of claim 9, wherein the loudness is estimated from an expression of total sound intensity, which is proportional to one divided by the distance squared plus one divided by a critical distance squared, where the critical distance is a distance from a loudspeaker at which the intensity of the direct sound is substantially equal to the intensity of reverberant sound.

11. The method of claim 1, wherein the direct sound level and loudness are estimated, at least in part, from one or more estimated impulse responses of each loudspeaker at the listening area.

12. The method of claim 1, wherein the estimation of the loudness is carried out in at least two frequency bands.

13. The method of claim 1, wherein at least one subset of two or more audio signals corresponds to a common audio signal, and wherein relative gains across the subset are maintained while the normalization factor across the subset is based on an estimation of the loudness of each loudspeaker in the listening area.

14. The method of claim 13, wherein the at least one subset of two or more audio signals is generated by extracting a common signal component from two or more of the one or more audio signals.

15. The method of claim 1, wherein a first loudspeaker of the set of loudspeakers is at a first distance from the listening area and a second loudspeaker of the set of loudspeakers is at a second distance from the listening area and wherein the first distance is different from the second distance.

16. The method of claim 1, further comprising providing the rendered audio signals to the set of loudspeakers.

17. An apparatus configured to perform the method of claim 1.

18. A system configured to perform the method of claim 1.

19. One or more non-transitory media having instructions encoded thereon for performing the method of claim 1.
